(19) United States
(12) Patent Application Publication
(10) Pub. No.: US 2014/0238119 A1
(43) Pub. Date: Aug. 28, 2014

(54) METHOD FOR OBTAINING EDGE PREP PROFILES OF CUTTING TOOLS

(71) Applicants: Xiaoming Du, Shanghai (CN); Kevin George Harding, Niskayuna, NY (US); Howard Paul Weaver, Mason, OH (US); James Allen Baird, Amelia, OH (US); Kevin William Meyer, Cincinnati, OH (US); Jiajun Gu, Shanghai (CN)

(72) Inventors: Xiaoming Du, Shanghai (CN); Kevin George Harding, Niskayuna, NY (US); Howard Paul Weaver, Mason, OH (US); James Allen Baird, Amelia, OH (US); Kevin William Meyer, Cincinnati, OH (US); Jiajun Gu, Shanghai (CN)

(21) Appl. No.: 14/345,966

(22) PCT Filed: Aug. 29, 2012
(86) PCT No.: PCT/US12/52761

§ 371 Date: Mar. 20, 2014

(30) Foreign Application Priority Data
Sep. 23, 2011 (CN) 201110304920.9

(51) Int. Cl. G01B 21/20

(52) U.S. Cl. CPC G01B 21/20
USPC 73/104

(57) ABSTRACT

A method for obtaining an edge prep profile of a cutting tool with a point sensor. The method includes: (a) scanning edge points of the cutting tool, including a target edge point on a target edge, with the point sensor, by rotating the cutting tool around its axis, to generate a first point cloud; (b) repositioning the point sensor and cutting tool relative to each other based on the location and orientation information of the target edge point, such that the sensor focus is at a region of interest containing the target edge point; and (c) scanning the region of interest using the point sensor to generate a second point cloud. The first point cloud includes location and orientation information of the target edge point. The second point cloud includes information for edge profile analysis.

### FIELD OF THE INVENTION

Embodiments of the present invention relate to methods for obtaining edge prep profiles of cutting tools. Embodiments of the present invention specifically relate to automated methods for obtaining edge prep profiles of cutting tools with a point sensor, from which edge prep profiles on cutting tools may be measured.

### BACKGROUND OF THE INVENTION

Various types of cutting tools are known and are in use for machining parts. It is well-known that prepping (e.g., honing, chamfering) edges on high performance cutting tools increases tool life and enhances machined part quality, when applied correctly. Many cutting tool manufacturers established various edge prepping processes to get desired cutting edges, for different applications, though they did not have a good way of measuring the edge preps on cutting tools, specifically, complex cutting tools. Moreover, in some cases, when users could not get satisfactory performance from purchased cutting tools, they may hone in-coming cutting tools by themselves. These honed edges over time might become unmanageable.

However, some machined parts are very sensitive to the edge preps of the cutting tools. For example, airfoil thickness may be very sensitive to improper edge prep treatment. A cutting edge with a too heavy hone may cause oversize conditions on the airfoil, due to deflection, resulting in additional, and costly, benching or rework. One with an edge prep that is too light, or with no edge prep at all, could result in undersize conditions, excessive chatter, broken cutters, and possibly even scrap hardware. As the demands for more accurate and robust cutting tools become greater, for creating tight tolerances on machined parts, the edge prep profile is getting more important for it affects the tool life, part quality, especially for the machining process with tight tolerances.

Therefore, it is necessary to know exactly the actual size and shape of a cutting edge.

There are commercial 3D profile measurement systems that can be used to measure the edge prep. One commercial system uses white light interferometry methods to create a very high resolution slice of the edge region. Another commercial system uses focus variation based or confocal imaging methods to define narrow vertical slices of the edge. These technologies focus on how to get high density and accurate data. Both of these systems are microscope based, able to measure only a very small region, typically much less than a millimeter at a time. To cover larger areas requires stitching of data, and continuous repositioning of the cutting tool. The cutting tool setup and repositioning with these current methods requires the operator to position the cutting tool and make sure the target region is within sensor's working range. Usually this manual positioning process is tedious and time consuming, and very dependent upon operator skill to obtain good quality data due to the very limited range of angles and measurement range of these methods.

Accordingly, it would be desirable to develop an improved technique for obtaining edge prep profiles of cutting tools.

### BRIEF DESCRIPTION

Embodiments of the invention provide an automated method for obtaining an edge prep profile of a cutting tool with a point sensor, from which edge prep profile parameters associated with the edge prep on the cutting tool, including but not limited to edge prep radii and chamfer width may be measured. The method comprises steps: (a) scanning edge points of the tool including a target edge point on a target edge using the point sensor, by rotating the tool around its axis, to generate a first point cloud, wherein the first point cloud includes location and orientation information of the target edge point; (b) repositioning the point sensor and tool relative to each other based on the location and orientation information of the target edge point, such that the sensor focus is at a region of interest containing the target edge point; and (c) scanning the region of interest using the point sensor to generate a second point cloud, wherein the second point cloud includes information for edge profile analysis.

### BRIEF DESCRIPTION OF THE DRAWINGS

FIG. 1 is a perspective view of an exemplary cutting tool.

FIG. 2 is a schematic diagram of a measurement system with a point sensor for obtaining edge profiles of rotary cutting tools in accordance with one embodiment of the invention.

FIG. 3 is a block diagram flow chart illustrating an automatic method for obtaining an edge profile of a rotary cutting tool using a measurement system with a point sensor, in accordance with one embodiment of the invention.

FIG. 4 is a diagram depicting how to specify a target edge point on a side edge of a cutting tool in accordance with one embodiment of the invention.

FIG. 5 is a diagram depicting how to specify a target edge point on a tip end edge of a cutting tool in accordance with one embodiment of the invention.

FIG. 6 is a diagram depicting how to specify a target edge point on a radius edge of a cutting tool in accordance with one embodiment of the invention.

FIG. 7 is a diagram depicting an exemplary point cloud obtained from a coarse scanning, which point cloud includes location and orientation information of the target edge point.

FIG. 8 is a diagram depicting how to calculate an angle which the cutting tool shall rotate from the point cloud of FIG. 7, in accordance with one embodiment of the invention.

FIG. 9 is a diagram depicting a line segment along which a trial scanning is carried out, in accordance with one embodiment of the invention.

FIG. 10 is a diagram depicting how to trim the line segment of FIG. 9 to get a shorter effective line segment scan path, in accordance with one embodiment of the invention.

FIG. 11 is a diagram depicting a zigzagging pattern along which the region of interest is rescanned, in accordance with one embodiment of the invention.

FIG. 12 is a diagram depicting how to specify an edge direction along which the zigzagging pattern of FIG. 11 extends, in accordance with one embodiment of the invention.

FIG. 13 is a diagram depicting an exemplary point cloud which includes information for edge profile analysis in accordance with one embodiment of the invention.

### DETAILED DESCRIPTION

Embodiments of the present disclosure will be described herein below with reference to the accompanying drawings. In the subsequent description, well-known functions or constructions are not described in detail to avoid obscuring the disclosure in unnecessary detail.

Approximating language, as used herein throughout the specification and claims, may be applied to modify any quantitative representation that could permissibly vary without resulting in a change in the basic function to which it is related. Accordingly, a value modified by a term or terms, such as “about” or “substantially”, is not to be limited to the precise value specified. In some instances, the approximating language may correspond to the precision of an instrument for measuring the value.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

In embodiments of the invention, edge profiles of different types of cutting tools, for example, rotary cutting tools, such as ball end mills, flat end mills, drills and reamers may be captured and measured.

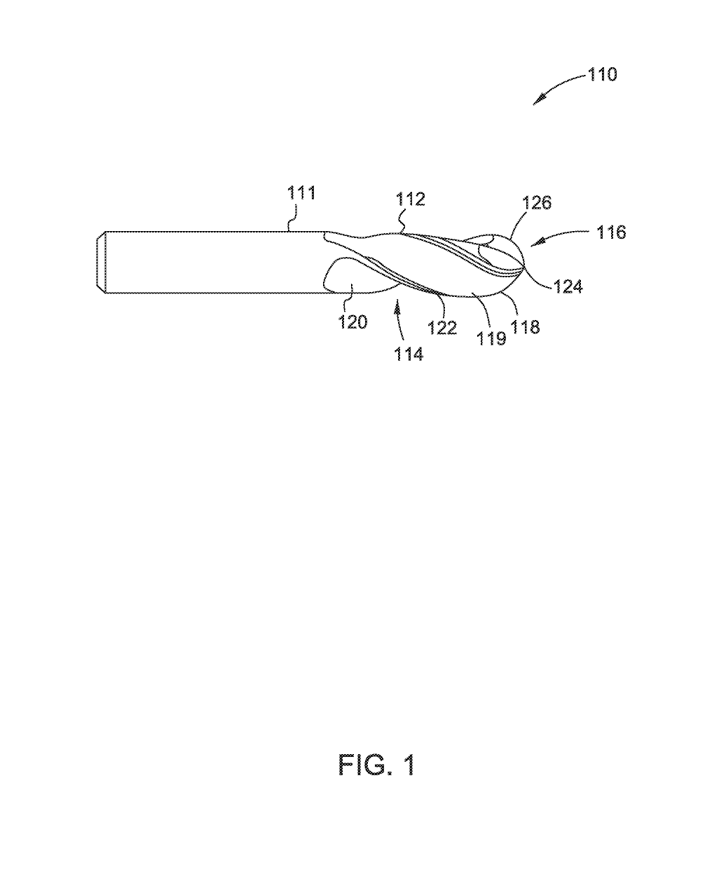

Referring to FIG. 1, a rotary cutting tool 110 such as a ball end mill is illustrated. The ball end mill 110 comprises a shank 111 and a cylindrical cutting body 112. The cutting body 112 comprises a side portion 114 and a rounded tip portion 116. In the illustrated embodiment, the cutting body 112 comprises multiple cutting edges 118 and multiple flutes 120 based on a desired profile of machined parts. In one example, a two-flute mill may be employed for cutting slots or grooves. A four-flute mill may be used for a surface milling operation. The edge 118 is formed by a rake face 119 and a primary relief surface or clearance surface (invisible from FIG. 1). The edges 120 comprise side edges 122, which are located at the side portion 114 of the cutting body 112, tip end edges 124, which are located at the tip end of the cutting body 112, and radius edges 126, which are located at an outer boundary or periphery of the rounded tip portion 116.

It should be noted that the invention is not limited to any particular type of cutting tool. Rather, the example depicted in FIG. 1 is merely illustrative.

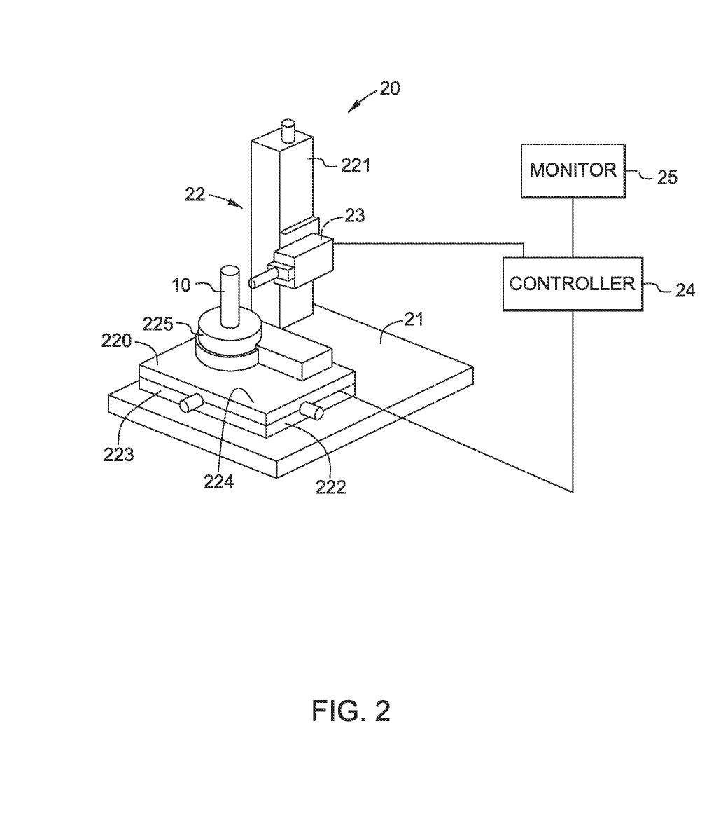

FIG. 2 is a schematic diagram of a measurement system 20 for obtaining an edge profile of a rotary cutting tool 10 in accordance with one embodiment of the invention. As illustrated in FIG. 2, the measurement system 20 comprises a base 21, a stage 22, a point sensor 23, and a controller 24. In the illustrated embodiment, the stage 22 comprises a first stage 220 and a second stage 221. The first stage 220 is movably disposed on the base 21 and comprises a positioning element 222 comprising a bottom element 223 and an upper element 224 stacked together. In one embodiment, the bottom element 223 and the upper element 224 may move along an X-axis and a Y-axis relative to the base 21, respectively. Additionally, the first stage 220 may further comprise a rotatable element 225 rotate-ably disposed on the upper element 224 for holding the rotary cutting tool 10. Accordingly, the rotary cutting tool 10 may move along the X-Y-axis and rotate about a Z-axis relative to the base 21 with the linear movement of the positioning element 222 and rotation of the rotatable element 225.

In one non-limiting example of the invention, the first stage 220 may move along the X-axis within a range of approximately zero millimeters to approximately fifty millimeters with a resolution of approximately 0.1 micrometers, and may move along the Y-axis within a range of approximately zero millimeters to approximately one hundred millimeters with a resolution of approximately 0.1 micrometers. In other embodiments, the first stage 220 may move along the X-axis and/or the Y-axis within other suitable ranges having any suitable resolution. Additionally, the rotatable element 225 may rotate approximately 360 degrees with a resolution of approximately 0.0001 degree. Alternatively, the rotatable element 225 may rotate within other suitable ranges with other suitable resolutions.

In the illustrated embodiment, the second stage 221 is fixed on the base 21 to movably hold the point sensor 23 and adjacent to the first stage 220. In one example, the point sensor 23 may move on the second stage 221 along the Z-axis. In more particular examples, the point sensor 23 may move along the Z-axis within a range of approximately zero millimeters to approximately 250 millimeters with a resolution of approximately 0.1 micrometers. In other embodiments, the point sensor 23 may move along the Z-axis within other suitable ranges and with other suitable resolutions.

In certain embodiments, the point sensor 23 may also move on the second stage 221 along the X-axis and Y-axis within a range and with a resolution substantially similar to these of first stage 220. In other embodiments, the second stage 221 may be movably disposed on the base 21. Accordingly, in embodiments of the invention, the controller 24 may control the first stage 220 and the second stage 221 to cooperate to position the point sensor 23 at variable distances from the rotary cutting tool 10 to measure the points on the rotary cutting tool 10.

In the illustrated embodiment, the controller 24 comprises at least one of a computer, a database, and/or a processor to control the movement of the stage 22 and the point sensor 23, and to store and analyze the measured data points from the point sensor 23. It should be noted that embodiments of the present invention are not limited to any particular computer, database or processor for performing the processing tasks of embodiments of the invention. The term “computer”, as that term is used herein, is intended to denote any machine capable of performing the calculations, or computations, necessary to perform the tasks of embodiments of the invention. The term “computer” is intended to denote any machine that is capable of accepting a structured input and of processing the input in accordance with prescribed rules to produce an output. The computer may be equipped with a combination of hardware and software for performing the tasks of embodiments of the invention, as will be understood by those skilled in the art. Additionally, the measurement system 10 may further comprise a monitor 25, such as a LCD to display data.

In one embodiment, each of the stages has accuracy better than 1 micron within 20 millimeters travel range. In one embodiment, the working range of the point sensor is about 0.2 millimeter and the point sensor has accuracy better than 1 micron and lateral resolution better than 4 micron.

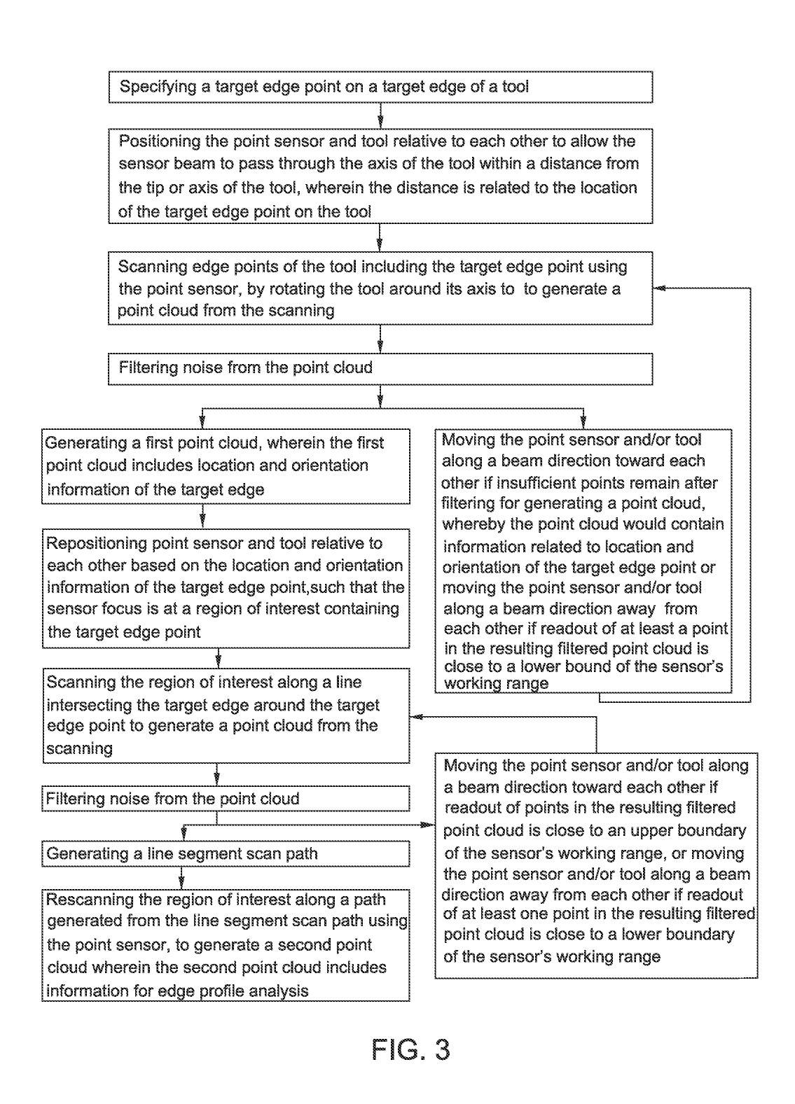

Methods for obtaining an edge profile of a cutting tool using a measurement system comprising a point sensor, in accordance with embodiments of the present invention, will be described herein below with reference to FIG. 3. As illustrated in FIG. 3, the method according to an embodiment comprises: (a) scanning edge points of the cutting tool including a target edge point using the point sensor, by rotating the cutting tool around its axis, to generate a first point cloud, wherein the first point cloud includes location and orientation information of the target edge point; (b) repositioning the point sensor and cutting tool relative to each other based on the location and orientation information of the target edge point, such that the sensor focus is at a region of interest containing the target edge point; and (c) scanning the region of interest using the point sensor to generate a second point cloud, wherein the second point cloud includes information for edge profile analysis.

As used herein, edge points refer to points located on edges of the cutting tool, formed by a rake face and a primary relief surface or clearance surface.

In one embodiment, the region of the interest is a patch region with a center at the target edge point. In a specific embodiment, the region of interest refers to a region of about 4-millimeter-square with the center of the region of interest at the target edge point.

The step (a) of the method (may be referred to as “coarse scanning” herein below) may comprise: (i) specifying a target edge point on a target edge; (ii) positioning the point sensor and cutting tool relative to each other to allow the sensor beam to pass through the axis of the cutting tool within a given distance from the tip or axis of the cutting tool, wherein the given distance is related to the location of the target edge point on the cutting tool; and (iii) scanning edge points of the cutting tool, including the target edge point using the point sensor, by rotating the cutting tool around its axis to generate a point cloud from the scanning.

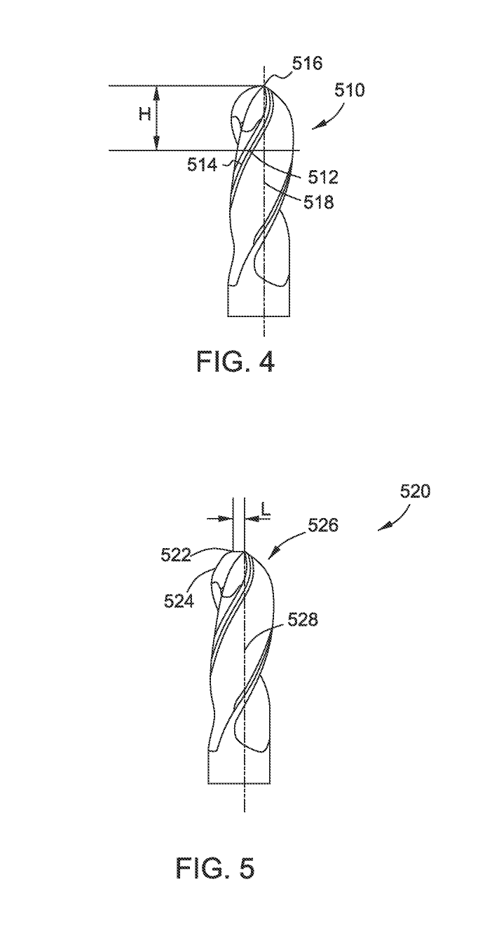

As illustrated in FIG. 4, as to a target edge point 512 on a side edge 514 of a cutting tool 510, it may be specified by a vertical distance H to the tip 516 of the cutting tool 510 and an index of the edge 514. For example, a target edge point may be specified on the third edge, at a vertical distance of about 5 millimeters from the tip of the cutting tool. Therefore, the point sensor may be positioned to allow the sensor beam to pass through the axis 518 of the cutting tool along a horizontal direction, which offsets from the tip 516 of the cutting tool 510 at a given vertical distance, wherein the given vertical distance is equal to the vertical distance H between the target edge point and the tip of the cutting tool.

As illustrated in FIG. 5, as to a target edge point 522 on a tip end edge 524 of a cutting tool 520 (a flat end mill), it may be specified by a horizontal distance L between the target edge point 524 and the axis 528 of the cutting tool 520, and an index of the edge 524. Therefore, the point sensor may be positioned to allow the sensor beam to pass through the axis 528 of the cutting tool along a tilted direction, from a point (may be or not be the target edge point) on a tip portion 526 of the cutting tool with a given horizontal distance from the axis, wherein the given horizontal distance is equal to the horizontal distance L between the target edge point and the axis of the cutting tool.

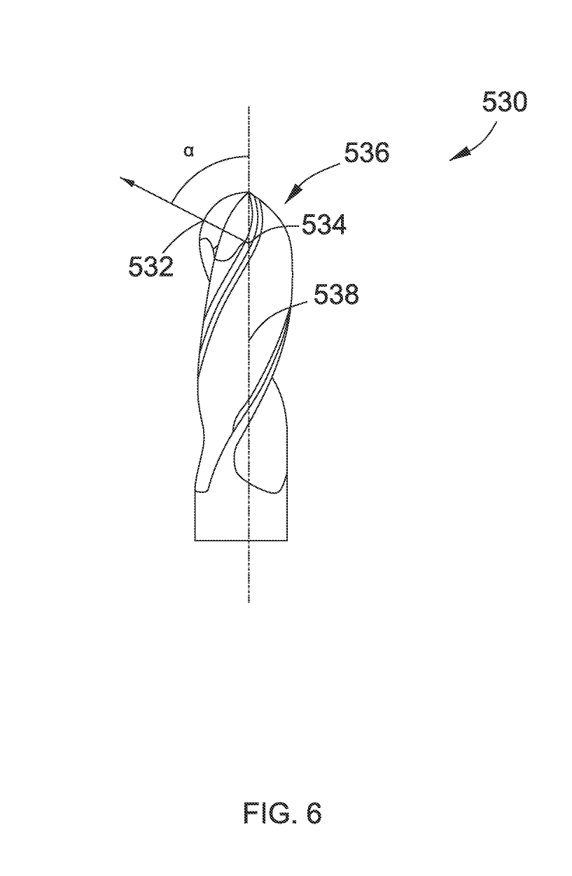

As illustrated in FIG. 6, as to a target edge point 532 on a radius edge of a cutting tool 530, if the target edge point 532 is orientated at greater than a 30 degree angle from the axis 538 of the cutting tool (an angle α between the axis 538 and a line linking the target edge point 532 and the center 534 of the circular arc where the target edge point is located, is greater than 30 degree), it may be taken as a side edge point, and the point sensor may be positioned to allow the sensor beam to pass through the axis of the cutting tool along a horizontal direction which offsets from the tip of the cutting tool at a given vertical distance, wherein the given vertical distance is equal to the vertical distance between the target edge point and the tip of the cutting tool; if the target edge point 532 is orientated at less than a 30 degree angle from the axis 538 of the cutting tool (α<30 degree), it may be taken as a tip end edge point, and the point sensor may be positioned to allow the sensor beam to pass through the axis of the cutting tool along a tilted direction from a point of the cutting tool with a given horizontal distance from the axis, wherein the given horizontal distance is equal to the horizontal distance between the target edge point and the axis of the cutting tool.

Therefore, the sensor beam is able to pass through the target edge point at least one time during rotation of the cutting tool around its axis, for example 360 degrees. Thus, edge points including the target edge point are scanned and a point cloud, which includes location and orientation information of the target edge point, may be generated.

In some cases, the cutting tool may be too close to the point sensor or too far from the point sensor to get an effective point cloud which includes location and orientation information of the target edge point. Under such circumstances, repositioning the point sensor and cutting tool relative to each other and rescanning may be needed. Therefore, in one embodiment, step (a) may further comprise: (iv) filtering noise from the point cloud obtained from step (iii); (v) moving the point sensor and/or cutting tool along a beam direction toward each other and repeating steps (iii) and (iv) if insufficient points remain after filtering for generating a point cloud including location and orientation information of the target edge point, or moving the point sensor and/or cutting tool along a beam direction away from each other and repeating steps (iii) and (iiv) if readout of at least one point in the resulting filtered point cloud is close to a lower boundary of the sensor's working range; and (vi) repeating step (iv) until a point cloud which includes location and orientation information of the target edge point is generated.

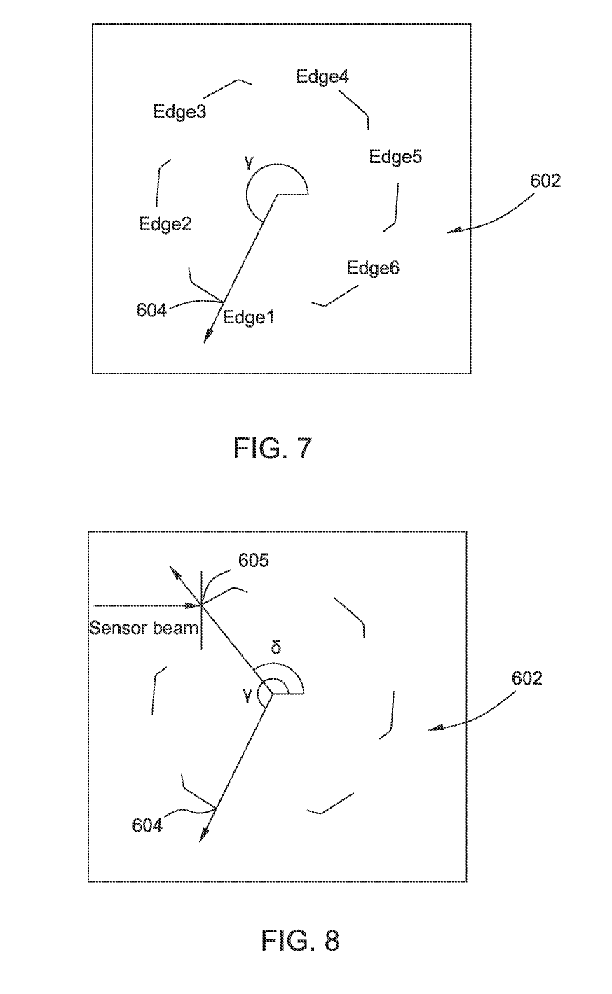

FIG. 7 illustrates an exemplary point cloud 602, including location and orientation information of the target edge point 604, which is obtained from the coarse scanning of the side edges of a rotary cutting tool. From the point cloud 602, it is able to detect edge points of all the side edges based on hull and gap threshold of the point cloud, and identify the target edge point 604 by an orientation angle γ of the target edge point. Based on the orientation angle γ of the target edge point 604, the cutting tool may be rotated to a proper position to enable the sensor focus at a region of interest around the target edge point 604.

In one embodiment, the step (b) of repositioning the point sensor and cutting tool relative to each other comprises: rotating the cutting tool around its axis with an angle, wherein the angle is determined from the location and orientation information of the target edge point. Referring to FIG. 8, there is a planned view position 605 where the target edge point 604 will be positioned during scanning. Thus, the angle which the cutting tool shall rotate is equal to the orientation γ of the target edge point 604 minus the orientation δ of the planned view position 605.

When the target edge point is positioned at the planned view position, such that the sensor focus is at the region of interest, it may be started to use the sensor to scan the region of interest to generate a second point cloud, wherein the second point cloud includes information for edge profile analysis.

Under some circumstances, to ensure the region of interest is scanned along an appropriate and effective path, the step (c) of scanning the region of interest may comprise: trial scanning the region of interest to generate a line segment scan path over the region of interest; and rescanning the region of interest along a path generated from the line segment scan path.

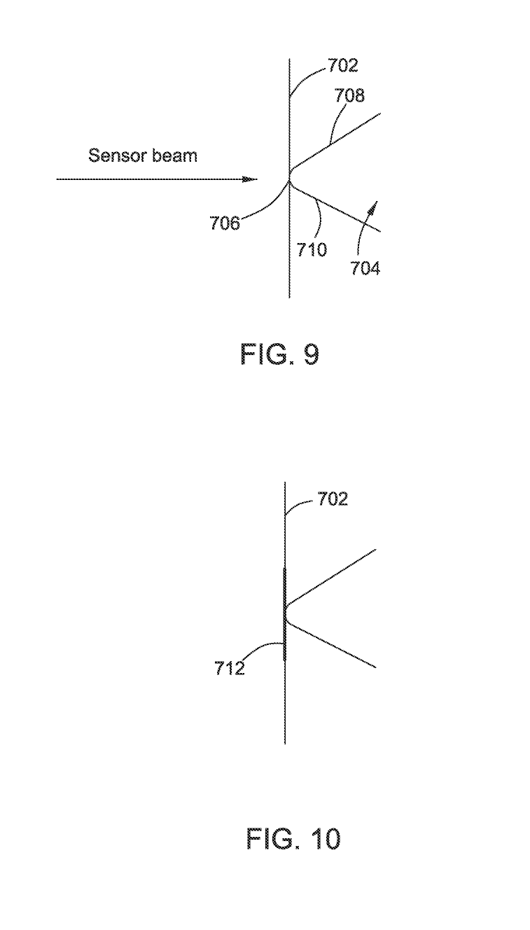

Referring to FIG. 9, the trial scanning is carried out along a line segment 702 intersecting the target edge 704 around the target edge point 706. In one embodiment, the trial scanning is carried out along a line segment which forms approximately equal angles with both side faces 708 and 710, which side faces intersect at the edge point 706 and shape the edge 704.

In some cases, the actual location of the target edge point may vary from the planned view position, and it is not able to get a correct line segment scan path with a single scanning. Under such circumstances, repositioning the point sensor and cutting tool relative to each other and rescanning may be needed. Therefore, in one embodiment, the step of trial scanning the region of interest to generate a line segment scan path over the region of interest comprises the following steps: (a′) scanning the region of interest along a line intersecting the target edge around the target edge point to generate a point cloud from the scanning; (b′) filtering noise from the point cloud obtained from step (a′); (c′) moving the point sensor and/or cutting tool along a beam direction toward each other and repeating steps (a′) and (b′) if insufficient points remain after filtering and insufficient points remain after filtering and readout of the points in the resulting filtered point cloud is close to an upper boundary of the sensor's working range, or moving the point sensor and/or cutting tool along a beam direction away from each other and repeating steps (a′) and (b′) if readout of at least one point in the resulting filtered point cloud is close to a lower boundary of the sensor's working range; and (d′) repeating step (c′) until a line segment scan path is generated.

The trial scanning enables the generation of a correct line segment scan path even when the actual location of the target edge point before trial scanning varies from the planned view position.

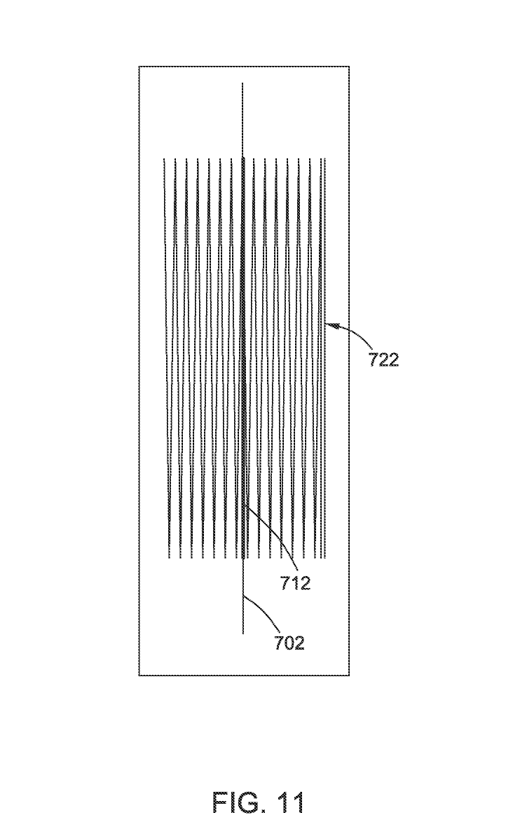

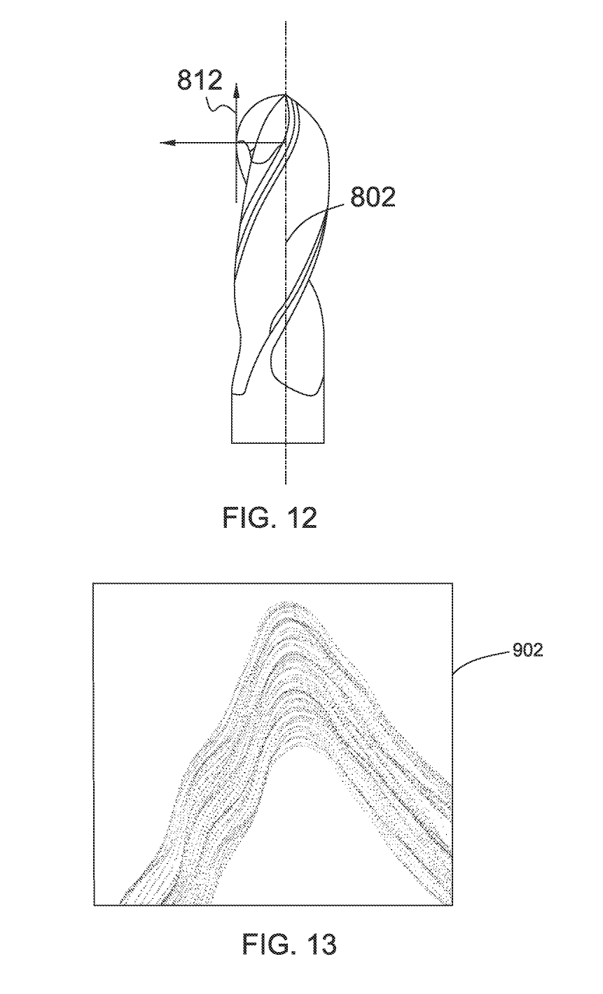

Referring to FIG. 10, the line segment scan path 702 may be trimmed, for example, to get a shorter effective line segment scan path 712. Referring to FIG. 11, the step of rescanning the region of interest may be carried out along a zigzagging pattern 722 the trimmed line segment scan path along the edge direction of the target edge. Referring to FIG. 12, as to a side edge, the edge direction may be approximately parallel to the axis 802 of the cutting tool; as to a tip end edge, the edge direction may be a direction from the planned view position to the tool center within a horizontal plane; as to a radius edge, the edge direction may be a direction 812 which is perpendicular to the direction from the planned view position to a radius center and within a plane determined by the axis of the cutting tool and the planned view position.

In one embodiment, the step of rescanning the region of interest along a path generated from the line segment scan path comprises: trimming the line segment scan path; and scanning in a zigzagging pattern the trimmed line segment scan path along the edge direction of the target edge, to generate a second point cloud, wherein the second point cloud includes information for edge profile analysis, such as a point cloud 902 as shown in FIG. 13.

Based on the second point cloud, parameters associated with the edge prep on the cutting tool, including, but not limited to, edge prep radii and chamfer width may be measured and calculated.

Embodiments of the invention provide a method capable of determining the shape of the cutting edge to optimize performance of the rotary cutting tool. It uses knowledge about the cutting tool, and location information obtained from a coarse scanning of the cutting tool to scan the cutting edge area to directly obtain measurement points using the point sensor. This method can significantly reduce the cutting tool setup time, and it also can align the local edge prep profile data with the macro cutting tool profile data, enabling visualization of the edge prep profile within the context of the overall cutting tool geometry. This ability to obtain more complete, integrated geometry information of the edge prep with the overall tool geometry permits significant analysis and optimization of cutting tool performance. Improved cutting tool performance can improve both tool life and critical part quality, and reduce machining times on critical parts such as aerospace components.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A method for obtaining an edge profile of a tool with a point sensor, the method comprising:
(a) scanning edge points of the tool, including a target edge point on a target edge, with the point sensor, by rotating the tool around an axis of the tool, to generate a first point cloud, wherein the first point cloud comprises location and orientation information of the target edge point;
(b) repositioning the point sensor and the tool relative to each other based on the location and orientation information of the target edge point, such that the focus of the point sensor is at a region of interest comprising the target edge point; and
(c) scanning the region of interest with the point sensor to generate a second point cloud, wherein the second point cloud comprises information for edge profile analysis.

2. The method according to claim 1, wherein the region of interest is a patch region with a center at the target edge point.

3. The method according to claim 1, wherein step (a) comprises:
(i) specifying the target edge point on the target edge;
(ii) positioning the point sensor and the tool relative to each other to allow the beam of the point sensor to pass through the axis of the tool within a distance from a tip or the axis of the tool, wherein the distance is related to the location of the target edge point on the tool; and
(iii) scanning edge points of the tool, including the target edge point, with the point sensor, by rotating the tool around the axis of the tool to generate a point cloud from the scanning.

4. The method according to claim 3, wherein step (a) further comprises:
(iv) filtering noise from the point cloud obtained from step (iii);
(v) moving the point sensor and/or the tool along a beam direction toward each other and repeating steps (iii) and (iv) if insufficient points remain in the filtered point cloud to generate another point cloud, wherein the point cloud comprises the location and orientation information of the target edge point, or moving the point sensor and/or the tool along a beam direction away from each other and repeating steps (iii) and (iv) if a readout of at least a point in the filtered point cloud is close to a lower boundary of the point sensor's working range; and
(vi) repeating step (v) until a point cloud comprising the location and orientation information of the target edge point is generated.

5. The method according to claim 3, wherein the target edge point is on a side edge of the tool, and wherein step (ii) comprises:
positioning the point sensor to allow the beam of the point sensor to pass through the axis of the tool along a horizontal direction which offsets from the tip of the tool at a given vertical distance,
wherein the given vertical distance is equal to a vertical distance between the target edge point and the tip of the tool.

6. The method according to claim 3, wherein the target edge point is on a tip end edge of the tool, and wherein step (ii) comprises:
positioning the point sensor to allow the beam of the point sensor to pass through the axis of the tool along a tilted direction from a point on a tip portion of the tool with a given horizontal distance from the axis,
wherein the given horizontal distance is equal to a horizontal distance between the target edge point and the axis of the cutting tool.

7. The method according to claim 3, wherein the target edge point is on a radius edge of the tool, and wherein step (ii) comprises:
positioning the point sensor to allow the beam of the point sensor to pass through the axis of the tool along a horizontal direction which offsets from the tip of the tool at a given vertical distance, if the target edge point is orientated at greater than or equal to 30 degree angle from the axis of the tool, wherein the given vertical distance is equal to a vertical distance between the target edge point and the tip of the tool; or
positioning the point sensor to allow the beam of the point sensor to pass through the axis of the tool along a tilted direction from a point on a tip portion of the tool with a given horizontal distance from the axis, if the target edge point is orientated at less than a 30 degree angle from the axis of the tool, wherein the given horizontal distance is equal to a horizontal distance between the target edge point and the axis of the cutting tool.

8. The method according to claim 1, wherein step (b) comprises:
rotating the tool around the axis of the tool with an angle,
wherein the angle is determined from the location and orientation information of the target edge point.

9. The method according to claim 1, wherein step (c) comprises:
trial scanning the region of interest to generate a line segment scan path over the region of interest; and
rescanning the region of interest along a path generated from the line segment scan path.

10. The method according to claim 9, wherein the step of trial scanning the region of interest to generate a line segment scan path over the region of interest comprises:
(a′) scanning the region of interest along a line intersecting the target edge around the target edge point to generate a point cloud from the scanning;
(b′) filtering noise from the point cloud obtained from step (a′);
(c′) moving the point sensor and/or the tool along a beam direction toward each other and repeating steps (a′) and (b′) if a readout of points in the filtered point cloud is close to an upper boundary of the sensor's working range, or moving the point sensor and/or the tool along a beam direction away from each other and repeating steps (a′) and (b′) if a readout of at least one point in the point cloud is close to a lower boundary of the sensor's working range; and
(d′) repeating step (c′) until the line segment scan path is generated.

11. The method according to claim 9, wherein the step of rescanning the region of interest along a path generated from the line segment scan path comprises:
trimming the line segment scan path; and
scanning the region of interest in a zigzagging pattern along the trimmed line segment scan path along an edge direction of the target edge.
